(19) United States
(12) Patent Application Publication
(10) Pub. No.: US 2011/0198861 A1
(43) Pub. Date: Aug. 18, 2011

(54) METHOD FOR PRODUCING ENERGY AND CAPTURING CO2

(75) Inventors: Simon Jallais, Chaville (FR); Ivan Sanchez-Molinero, Versailles (FR)

(73) Assignee: L'Air Liquide Societe Anonyme pour l'Etude et l'Ex ploitation des Procedes Georges Claude, Paris (FR)

(21) Appl. No.: 13/124,103

(22) PCT Filed: Oct. 6, 2009
(86) PCT No.: PCT/FR09/51894

§ 371 Date: Apr. 13, 2011

(30) Foreign Application Priority Data
Oct. 15, 2008 (FR) 0856995

(51) Int. Cl. B01D 53/62; F01K 13/00; H02K 7/18; B01J 8/04

(52) U.S. Cl. 290/1 R; 60/645; 423/224; 422/619

(57) ABSTRACT

Method for producing energy by oxidizing a carbon-containing fuel (4) and for capturing the resultant carbon dioxide (CO2), comprising:—a chemical loop step (1),—a secondary oxidation step (12),—a heat exchange transfer (10a-10f),—a post-treatment (16)

The present invention relates to a method for producing energy by oxidizing a carbon-containing fuel, comprising the capture of the carbon dioxide produced, and to a device implementing this method.

Carbon dioxide (CO₂) is produced in large quantities by certain human activities, particularly during the industrial production of energy relying upon the oxidation of carbon-containing compounds, typically the combustion of fuels known as “fossil” fuels (natural gas, coal, oil and derivatives thereof). For environmental and/or economic reasons, industry is increasingly desirous to reduce, or even eliminate, discharges of CO₂ into the atmosphere by storing it in appropriate geological layers or by realizing its asset value as a product.

In the absence of special treatments, CO₂ is found in the flue gases, mixed with other products of the reactions involved, and/or with compounds which have not reacted or have reacted incompletely and/or possibly with compounds that are either not very reactive or are inert, for example nitrogen in the case of conventional combustion in air. Now, in order to store this CO₂ or realize its asset value it is desirable, or even necessary, to obtain it in a sufficiently concentrated form. For example, for energy cost and economic reasons, it is not desirable to compress, transport or store anything other than CO₂. Further, certain residual compounds may be detrimental to a given use, such as, for example, oxygen or oxides of nitrogen in the case of EOR (enhanced oil recovery).

A certain number of techniques have therefore been developed for oxidizing said fuel, recuperating the heat released and obtaining a CO2-rich post-reaction mixture. These can be divided into two broad families.

The first encompasses methods which involve a significant post-treatment of the flue gases or blowdown likenable to separations or purifications of the CO2. Particular mention may be made of the following post-treatments:
amine scrubbing. These amines fix the CO2, then restore it under heating. The solution of amines used has certain disadvantages of corrosion and of toxicity, and also requires a great deal of energy in order to regenerate the amine solution by heating and the solution in question becomes degraded upon contact with pollutants present in the flue gases. Document U.S. Pat. No. 4,440,731 for example describes the method of absorbing CO2 in flue gases of combustion in air by contact with an aqueous solution of alkanolamine. It proposes the use of additives to reduce the degradation of the solution and to reduce the corrosion that this solution causes to metals. Document U.S. Pat. No. 5,318,758 discloses a device for removing the CO2 from exhaust gas using an absorbent containing an aqueous solution of alkanolamine;
ammonia scrubbing. This uses a regenerative ammonium carbonate/bicarbonate cycle. The regeneration step consumes less energy that the method above, but the energy required is nonetheless considerable and industrialization of the method is ongoing. This method is described in U.S. Pat. No. 7,255,842 B1, in which flue gases of conventional combustion in air are cooled then oxidized in order to cause them to react with ammonia-containing compounds thus producing ammonium salts;
separation by selective adsorption, for example on molecular sieves using PSA/VSA (pressure swing adsorption/vacuum swing adsorption) techniques. This has the disadvantage of being limited in size. Further, degradation of the adsorbents by pollutants may occur;
separation by permeation through membranes. This too has limits on size and the same problem of degradation of the membranes by certain pollutants;
cryogenic distillation or cryogenic solidification. These two technologies are fairly difficult to implement. This methods are covered by documents EP 13555716 and EP 1601443, which add to the capture of the CO2 that of the SO2 that could potentially be present in the flue gases.

The second family covers methods aimed at oxidizing said fuel and at recuperating heat without introducing undesirable compounds that reappear unchanged in the flue gases or blowdowns, or lead to the presence of undesirable elements in these flue gases or blowdowns.

Particular mention may be made of oxycombustion, or more generally, methods in which the oxidant is a somewhat oxygen-enriched mixture, extending as far as pure oxygen. Optionally, a fraction of the flue gases may be recirculated for thermal reasons (ballast effect) and/or rectional reasons (if they contain reagents of interest). These methods consume a great deal of oxygen, generally resulting from a separation of air by cryogenic distillation. Further, depending on the degree of enrichment of the oxidant with oxygen, special materials may prove necessary, or alternatively special-purpose devices, such as burners or heat exchangers. Document U.S. Pat. No. 6,955,051 describes a boiler for producing steam by burning a fuel with an oxidant the oxygen concentration of which is higher than that of air. Document U.S. Pat. No. 6,436,337 for its part describes a system for combustion in oxygen comprising a furnace with at least one burner, means for providing a flow containing at least 85% oxygen and a carbon-containing fuel and control devices. The report entitled Cost and Performance Baseline for Fossil Energy Plants Desk Reference published by the DoE (Department of Energy) of the United States in May 2007 provides a description of this technology, with detailed mass and energy data.

This second category also includes gasification, which consists in partial oxidation of the fuel, followed by treatments to remove carbon from the synthesis gas produced. The decarbonized synthesis gas can then be used as a fuel in a special-purpose combustion turbine. This method also consumes fairly pure pressurized oxygen. In addition, the combustion turbine has not yet been developed on an industrial scale. The report entitled Cost and Performance Baseline for Fossil Energy Plants Desk Reference, mentioned above, also provides a detailed description of this technology.

More recently, techniques known as “chemical looping” techniques have emerged. These do not require the use of a special-purpose oxidant, and this in particular avoids having to inject oxygen obtained in general by cryogenic distillation. They use a solid active compound, generally metallic, which chemically fixes the oxygen of a gaseous mixture containing oxygen and then serves to oxidize a solid, liquid or gaseous carbon-containing compound. In general, said active compound circulates in a loop from a reactor in which it is oxidized in contact with an oxygen-containing gaseous mixture to at least one other reactor where it is reduced during the oxidation reaction of said carbon-containing fuel. This reduction regenerates the compound, that can once again be used to fix oxygen. The active compound is generally used in the form of a bed of fluidized and circulating particles. It can easily be separated from the gaseous mixtures, for example using a cyclone.

Particular mention may be made of document WO2007104655A1 which describes a power station including thermochemical looping, comprising oxidation and reduction chambers, cyclones for separating solid particles from the effluent gases, heat exchangers and means for producing electrical energy from the thermal energy released. Application WO2008036902, “Chemical looping combustion”, sets out one implementation of the principle of chemical looping, particularly using a reactor made up of rotary compartments.

Unfortunately, in the current state of the art of chemical looping as applied to the oxidation of a carbon-containing fuel, the flue gases produced by the reaction generally contain undesired, or even toxic, compounds such as CO. For this reason, chemical looping techniques do not allow easy capture of CO2.

It is one object of the present invention to alleviate all or some of the disadvantages of the prior art, particularly the consumption of vast quantities of an oxidant generally requiring a unit for separating air by cryogenic distillation or systematic recourse to significant post-treatments of the method flue gases or blowdown.

The invention relates first of all to a method of producing energy by oxidizing a carbon-containing fuel and of capturing the resultant carbon dioxide (CO2), comprising:

a) a chemical looping step in which said fuel is oxidized by contact with at least one active oxygen-carrying compound, this oxidation producing primary effluents and reducing said active compound, said reduced active compound then being recuperated, regenerated by oxidation upon contact with an oxygen-containing gas, said regeneration producing regeneration effluents and said regenerated active compound being recuperated to oxidize said fuel;
b) a step of secondary oxidation of said primary effluents by at least one gas containing predominantly oxygen, said secondary oxidation producing secondary effluents;
c) a transfer by exchange of heat to at least one heat-transfer fluid of at least some of the heat released by said chemical looping and secondary oxidation steps; and
d) a post-treatment of said secondary effluents comprising one or more of the following operations: drying by condensing the water, compression, cooling, passage over adsorbents and/or polymer and/or ceramic membranes, cryogenic distillation.

It may be seen that the solution according to the invention chiefly combines two oxidation steps a) and b) with a step c) of recuperating the energy released by the oxidation steps and a step d) of treating and conditioning the effluents. Although steps a) and b) are opposable from an oxygen consumption standpoint, the inventions have established that it is technically and economically advantageous to combine them. Specifically, the chemical looping step a) is known not to require particularly pure oxygen, and therefore in theory not to require separation of air, whereas step b) requires an oxidant containing predominantly oxygen, that is to say at least 50% by volume of oxygen, and this generally does require separation of air. It is also preferable for this oxidant not to contain undesirable elements (nitrogen, inert compounds, compounds that have not been completely oxidized, etc). For preference, the oxidant used in step b) contains at least 95% oxygen by volume and, more preferably still, at least 99%.

Combining the two steps a) and b) has the advantage of generating flue gases that allow easy capture of the CO2. In particular, undesired species such as H2, CO, CH4 or even NH3, H2S or hydrocarbons, can be found in very small, or even zero, quantities in the effluents. Thanks to step b), which uses an oxidant which is rich in oxygen by comparison with air, the quantities of inert gases other than CO2 and H2O, such as N2 or Ar, are considerably reduced in the effluents. Moreover, the inventors have determined that the quantities of oxidant required in step b) remain reasonable.

Furthermore, combining the two steps a) and b) makes it possible to generate more energy from the same reference flow rate of fuel than could be generated if there was only a chemical looping oxidation.

In step d) a purification of the CO2 may prove beneficial in some cases, for example if in step b) use has been made of an excess of oxygen by comparison with the stoichiometric quantity and if no residual oxygen in the flue gases is desired or alternatively if the CO2 is intended for a particular application that requires a very high degree of purity. In all cases, steps a) and b) mean that the requirements to be met in step d) are not too severe. This allows for savings on the individual method or methods of which it is composed.

The carbon-containing fuel may be solid, liquid or gaseous, or polyphasic. It may be a conventional fuel such as natural gas or naphtha or a blowdown from some other method, or coal, coke, petroleum coke, biomass or petrochemical residue.

In step a) it is brought into contact with one or more oxygen-carrying active compounds. This contact may be simultaneous or successive. These active compounds may notably be metals, in either an oxidized or a reduced form. The terms “oxidized” and “reduced” must be assigned a relative meaning here. The essential thing is for the active compounds to be able to fix the oxygen by progressing to a higher degree of oxidation and to release the oxygen by returning to a lower degree of oxidation.

The carbon-containing fuel reacts with an oxidized form of the active compounds. This results firstly in the active compound(s) being in a reduced form and, secondly, in effluents which are the products of the oxidation of said fuel. The active compounds are recuperated, for example by physical separation, then brought into contact with an oxygen-containing gas. Upon contact therewith, the active compounds fix oxygen. This may occur simultaneously or in succession and may take several steps. On completion of this regeneration, they are once again ready to be used for oxidizing said fuel.

In general, the oxidation of the active compounds in the chemical looping reaction is an exothermal oxidation, while their reduction in contact with the fuel is an endothermal reaction. Nonetheless, it occurs at high temperature. The secondary oxidation in step b) is also exothermal.

In step b), the primary effluents are oxidized by an oxygen-containing gas. The inventors have established that it is preferable for oxidation to be carried out in the presence of one or more catalysts. These may, in particular, contain one or more of the following chemical elements: Fe, V, Co, Rh. The reaction normally takes place at an absolute pressure of below 50.10⁵ Pa (namely 50 bar absolute), at a temperature normally below 1000° C. It produces hot effluents in which steps are taken to ensure that the residual oxygen content is generally below 5% by volume, preferably below 2% by volume. Steps are generally also taken to ensure that the residual content of reactive gases (CO, H2, CH4, hydrocarbons) is below 5% by volume, preferably below 2% by volume. The question is therefore one of performing a chemical reaction with the addition of reagents in proportions close to stoichiometric proportions and of obtaining high reaction rates, so as to reduce the presence of excess reagents.

Some of the heat released by the chemical reactions performed in steps a) and b) is recuperated by exchange of heat. This is the subject of step c) of the method according to the invention. It is important to note that this step c) may comprise numerous exchanges of heat so as to recuperate heat from wherever this heat may be found. This heat may be recuperated notably in or around the reaction environments, or alternatively in the primary, secondary and/or regeneration effluents. The thermal energy is partially transferred to one or more heat-transfer fluids such as steam or hot oil, according to approaches known to those skilled in the art. These fluids, potentially produced at different pressure and/or temperature levels, can be used as they are or can be used Co produce mechanical and/or electrical energy.

The exothermal secondary oxidation step may take place on a hot effluent leaving the chemical looping step, with the advantage of generating, during the secondary oxidation reaction, heat which will be available at a higher temperature. This allows a higher conversion efficiency in terms of work or electricity. The secondary oxidation may also take place on an effluent which has undergone cooling on leaving the chemical loop, making said secondary oxidation easier, with fewer construction or materials constraints. If the aforementioned cooling is substantial, it may lead to the condensation of the water contained in the flue gases, this having the advantage of reducing the overall volume of gas to be treated in b).

The water contained in the effluents from steps a) and/or b) may possibly be separated from the main flow by cooling which causes it to condense and/or by an additional drying operation. This may also take place only at step d).

The secondary effluents are post-treated in step d). This step may include one or more operations. The type of operation and order in which they are performed will depend on the ultimate purpose for which the CO2 is being captured, according to methods conventional to those skilled in the art. Particular mention may be made of the following operations:
effluent cooling, allowing water to condense and separate, it being possible for said cooling to be performed by exchange of heat with a heat-transfer fluid, in an open or closed circuit. The asset value of the recuperated energy may be realized or the energy may be dissipated into the environment;
removal of nitrogen from flue gases (de-NOx treatment) by the addition of ammonium, urea or other nitrogen-containing compounds, either catalytically or otherwise (conventional industrial processes known as SCR or NSCR);
removal of sulfur from flue gases, using conventional industrial processes, for example by reacting with CaCO3 or Ca(OH)2, by amine scrubbing (using the Cansolv method) or the like;
removal of dust, for example by filtration (i.e. bag filter, ceramic filter) and/or by electrostatic precipitation (wet or dry);
scrubbing, removing certain compounds by bringing them into contact with aqueous solutions and allowing these flue gases to be cooled;
compression, in equipment according to the prior art, for example using isothermal or adiabatic means, with or without the exchange of heat with other fluids, and with or without the asset value of this heat being realized;
drying and/or adsorption of undesired compounds, for example using regenerative methods such as adsorption on alumina, silica gel, zeolite, molecular sieve, active charcoal (alone or in combination) or physical absorption using alcohols;
purification of compounds present in trace form, for example heavy metals (i.e. Hg, V, Pb), halides (i.e. Na, K), acids (i.e. HCl, HF), nitrogen-containing compounds (i.e. oxides of nitrogen, ammonia), sulfur-containing compounds (i.e. oxides of sulfur, H2S) for example by physical or chemical adsorption on beds of doped or undoped active charcoal or other materials;
phase separation, making it possible to reduce the content of more volatile compounds (i.e. N2, Ar, O2) in the liquid phase, which will be CO2-enriched;
cryogenic distillation, which allows for greater separation of the more volatile compounds and, in particular, makes it possible to attain very low concentrations of oxygen and of oxides of nitrogen in the CO2-rich main product;
pumping to increase the pressure of the CO2-rich flow once it is in a liquid phase or supercritical state.

The characteristics of step d) may be influenced by the preceding steps. For example, if catalysts sensitive to pollutants present in the effluents being treated are used in step b) then some of the operations mentioned hereinabove as potentially forming part of step d) are instead carried out prior to step b). In particular, if the catalyst contains metallic cobalt (Co), it may be inactivated by the presence of sulfur in the effluent that is to be oxidized. In such a case, it is necessary to include sulfur removing and trace purification operations prior to step b).

According to some particular embodiments, the method in question may further comprise one or more of the following features:
said active compound used in said chemical looping step is in the form of solid particles;
said method comprises a transfer by exchange of heat to at least one heat-transfer fluid of at least some of the heat contained in said solid particles.

In step a), said oxygen-carrying active compound or compounds are generally used in the form of solid particles. These particles are made up of the active compound or compounds, possibly agglomerated by a binder using techniques known to those skilled in the art. The latter will notably contrive to:
give them a specific capability (per unit mass) of fixing and releasing oxygen that is as high as possible,
give them good mechanical strength, particularly in terms of attrition,
encourage the dynamics of the reaction between said particles and said carbon-containing fuel and between said particles and the oxygen-containing gas. This feature may be termed reactivity.

Said particles are generally used in the form of a fluidized bed, for example by injections of steam or of CO2-rich gas or of fuel gas into a reactor, and injections of air or of some other oxygen-containing gas or of steam into another reactor. This steam may be produced in the heat exchangers. This fluidized bed flows from the regions where the reduction of said particles occurs, that is to say where the oxidation of said fuel occurs, toward the regions where the regeneration of said particles occurs, that is to say where the oxidation of the active compounds they contain occurs.

Said particles are generally separated from the other products of the oxidation of said fuel by physical separation, for example in a cyclone. They are also separated from any other potential solids resulting from the oxidation of the fuel (ash and/or soot and/or unconverted solid fuel). The same goes for the regeneration of said particles. Other separation elements may be provided for separating off any potential solid products of the reactions of the active oxygen-carrying compound so that the carrying material can be recuperated and the conversion efficiency improved.

Because the reactions of oxidizing the fuel on contact with the active compound and of regenerating said active compound on contact with an oxygen-containing gas generally take place at high temperature, it may be advantageous to extract the heat contained in the active compound once said primary and/or regeneration effluents have been separated off.

According to other particular embodiments, the method according to the invention may further comprise one or more of the following features:
said gas used to oxidize said active compound in said chemical looping step is air;
the effluents from said regeneration of said oxygen-carrying active compound are used to prepare a gas with a reduced oxygen content;
some of the energy contained in said heat-transfer fluid is converted into mechanical and/or electrical energy.

Optionally, at least some of the effluents from the secondary oxidation b) and/or from the post-treatment d) may also be recirculated. This or these flows may be incorporated into step a) upstream of the oxidation reaction of said carbon-containing fuel and/or into step b) upstream of the secondary oxidation reaction. This may afford an advantage if the effluents in question still contain reagents of use, or alternatively if there is a need to create a ballast effect.

Moreover, the effluents resulting from the regeneration of the active compounds in step a) are oxygen-lean. By creating a sufficient degree of leaness, the invention has the additional advantage of providing a residual gas that can be used in inerting applications.

Some of the heat-transfer fluids produced by exchange of heat can be converted into mechanical energy, for example in a steam turbine. Some of this mechanical energy can then be converted into electricity.

The invention also relates to a device for producing energy by oxidizing a carbon-containing fuel and for capturing the resultant CO2, comprising:
a plant comprising a chemical loop including at least one reactor for oxidizing said carbon-containing fuel in contact with solid particles incorporating at least one active oxygen-carrying compound, said chemical loop relating to said particles;
a reactor for oxidizing a gas, having at least one inlet for said gas to be oxidized and at least one other inlet connected to a source of gas containing predominantly oxygen; and
at least two heat exchangers for heating at least one heat-transfer fluid, one situated inside said plant comprising a chemical loop, and the other at said reactor used for oxidizing said gas it being possible for said exchangers to be within said reactors or alternatively for said effluents and/or said solid particles to pass through them;
   characterized in that said inlet for the gas that is to be oxidized in said catalytic oxidation reactor is connected to at least one outlet of said reactor for oxidizing said fuel in such a way as to receive effluents produced by said reactor for oxidizing said fuel.

Said exchangers may be situated within said reactors, or alternatively said effluents and/or said solid particles may pass through them.

According to some particular embodiments, the device according to the invention may comprise one or more of the following features:
it comprises at least one steam turbine connected at input and/or in its intermediate stages to one or more steam pipes leading from said heat exchangers;
said steam turbine is mechanically coupled to an electricity generator so as to be able to drive said generator.

The device preferably operates at a pressure higher than that of the surroundings and incorporates means for ensuring that the various components are correctly sealed, to avoid any potential ingress of air which in particular would introduce nitrogen and oxygen into the effluents. Nor must the operating pressure be excessively high because that would lead to additional energy expenditure in the compression of the gases and to constructional constraints. The ideal target pressure is between −0.1 barg and 1 barg, preferably between −0.05 barg and 0.3 barg.

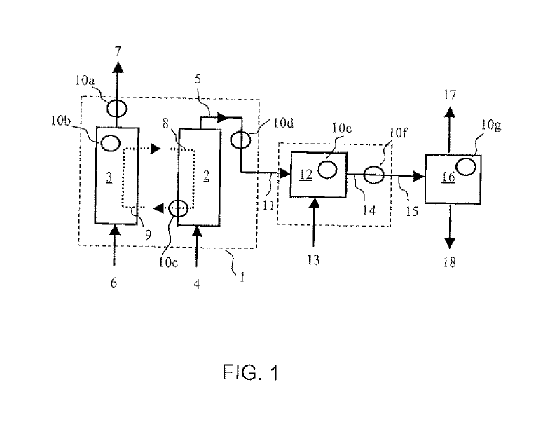

Other specifics and advantages of the invention will become apparent from reading the following description which is given with reference to FIG. 1 which depicts a plant that implements the method according to the invention.

In FIG. 1, a coal 4 is oxidized in contact with solid ilmenite in the reactor 2. This oxidation produces primary effluents 5 and ilmenite in reduced form 9. The latter is introduced into the reactor 3 where it undergoes oxidation upon contact with air 6. This reaction produces an oxygen-lean air 7 which can be used for its inerting properties and ilmenite which is sent back to the reactor 2 to oxidize the coal 4. Tubular heat exchangers 10a, 10b, 10c, 10d are positioned on the outlet streams from these reactors in order to produce steam. This steam is introduced into a steam turbine, not depicted in the figure, to produce electricity. The primary effluents 11 and pure oxygen are then introduced into the secondary oxidation reactor 12 which consists of a bed of solid vanadium oxide and contains within it a heat exchanger 10e. This reaction produces secondary effluents 14 which are free of carbon monoxide, of hydrocarbons and of hydrogen sulfide, the heat of which is recuperated by use of a tubular exchanger 10f. The cooled secondary effluents 15 consisting predominantly of carbon dioxide are then carried to a post-treatment facility 16 consisting of an adsorption drying and a cryogenic distillation step. This post-treatment produces CO2 17 in supercritical form and a stream 18 containing the residual impurities such as nitrogen, oxygen and argon. During the post-treatment, at the time of compression of the CO2, heat is recuperated in the exchanger 10g. The product 17 is then sent to an appropriate underground storage site.

The following example notably illustrates the combination of steps a) and b) in the method according to the invention.

An enumerated example of a chemical loop is given in the article entitled Design and operation of a 10 kWth chemical-looping combustor for solid fuels—Testing with South African coal, from Fuel magazine No 87, 2008, p. 2713-2726. The article recounts an experiment in which the carbon-containing fuel 4 is a South African coal. Its oxidation 2 takes place in a fluidized bed and the active oxygen-carrying compound 8, 9 is ilmenite, a natural oxide of iron and titanium, in granular form. A reactor 3 for the regeneration of the active compound is used, with air 6 by way of oxidant. The rate of flow of coal 4 introduced corresponds to a thermal power of 3.3 kW, the temperature being in excess of 850° C. The tests ran for over 22 hours.

Column A of Table 1 below gives the average composition of the gaseous effluents 5 leaving the reactor 2 in which the coal 4 is oxidized, as calculated by the inventors from the data given in the article. It may be seen that the mixture 5 still contains compounds that are undesirable to the capture of CO2, certain of them being toxic, such as CO.

The inventors then performed method calculations corresponding to the combination of the chemical loop 1 performed in step a) with the secondary oxidation 12 performed in step b). For the chemical loop, they incorporated the average composition estimated on the basis of the article. They gauged the secondary oxidation reaction 12 on the basis of a flow rate of 329 t/h of effluents 11 from the coal oxidation reactor 2, corresponding to an overall plant size capable of producing 450 MWE. The secondary oxidation reaction 12 was calculated under adiabatic conditions (but could have been calculated in an exchanger reactor) from reagents 11, 13 considered at ambient temperature.

Column B of Table 1 gives, for an oxidant 13 containing 95 vol % O2, 3 vol % N2, 2 vol % Ar: the composition and flow rate of the gas 14 leaving the secondary oxidation reactor 12, the required flow rate of oxidant 13 and the thermal power that can be recuperated from the flue gases 14 assuming that these flue gases 14 are cooled down to a temperature of 100° C. in an exchanger 10f. Column C of Table 1 gives the same parameters for an oxidant 13 containing 99.5% O2 and 0.5% Ar.

TABLE 1

| | A | B (O2 95%) | B (O2 99.5%) |
|---|---|---|---|
| CO2 vol % | 80.00 | 83.10 | 83.58 |
| H2O vol % | 3.00 | 14.86 | 14.94 |
| SO2 vol % | 0.50 | 0.46 | 0.47 |
| N2 vol % | 1.00 | 1.31 | 0.93 |
| CO vol % | 6.00 | 0.00 | 0.00 |
| H2 vol % | 6.00 | 0.00 | 0.00 |
| CH4 vol % | 3.50 | 0.00 | 0.00 |
| O2 vol % | 0.00 | 0.01 | 0.01 |
| Ar vol % | 0.00 | 0.25 | 0.06 |
| Flue gases (t/h) | 329 | 366 | 365 |
| O2 injected (t/h) | — | 37.3 | 35.6 |
| Energy output | — | 134 | 134 |
| (MW th) | | | |

It can therefore be seen that the composition of the effluents 14 resulting from the secondary oxidation 12 is far better suited to the capture of CO2. Specifically, there is practically now no more CO, H2 or CH4. The amount of residual oxygen and argon is minimal. An extremely reduced amount of post-treatment that forms the subject of step d) of the method according to the invention is then sufficient to condition the CO2 so that it can be stored or used as a product. Further, the secondary oxidation step allows the release of additional energy representing 134 MWth, for an injected oxidant flow rate of the order of 35 to 37 metric tons/h.

From the above explanations it will be appreciated that the main advantages of the invention are an increase in the recuperated thermal power and a reduction in the quantity of undesired compounds in the CO2 to be captured, such as inert compounds, oxygen, hydrogen, H2S, NH3, CO, CH4 and hydrocarbons, through a reasonable consumption of oxidant containing predominantly oxygen.

1-9. (canceled)

10. A method of producing energy by oxidizing a carbon-containing fuel (4) and capturing the resultant carbon dioxide, the method comprising the steps of:
a) a chemical looping step (1) in which said fuel (4) is oxidized by contact (2) with at least one active oxygen-carrying compound, this oxidation producing primary effluents (5) and reducing said active compound, said reduced active compound then being recuperated, regenerated by oxidation upon contact (3) with an oxygen-containing gas (3), said regeneration (3) producing regeneration effluents (7) and said regenerated active compound being recuperated to oxidize said fuel (4);
b) a step of secondary oxidation (12) of said primary effluents (11) by at least one gas (13) containing predominantly oxygen, said secondary oxidation (12) producing secondary effluents (14);
c) a transfer by exchange of heat (10a, 10b, 10c, 10d, 10e, 10f) to at least one heat-transfer fluid of at least some of the heat released by said chemical looping (1) and secondary oxidation (12) steps; and
d) a post-treatment (16) of said secondary effluents (14) comprising one or more of the following operations: drying by condensing the water, compression, cooling (10g), passage over adsorbents and/or polymer and/or ceramic membranes, cryogenic distillation.

11. The method of claim 10, wherein said active compound used (8, 9) in said chemical looping step (1) is in the form of solid particles.

12. The method of claim 10, wherein said gas (6) used to oxidize said active compound in said chemical looping step (1) is air.

13. The method of claim 10, wherein the effluents (7) from said regeneration (3) of said oxygen-carrying active compound are used to prepare a gas with a reduced oxygen content.

14. The method of claim 10, wherein some of the energy contained in said heat-transfer fluid is converted into mechanical and/or electrical energy.

15. A device for producing energy by oxidizing a carbon-containing fuel (4) and for capturing the resultant carbon dioxide, the device comprising:
a plant (1) comprising a chemical loop (8, 9) including at least one reactor (2) for oxidizing solid carbon-containing fuel (4) in contact with solid particles incorporating at least one active oxygen-carrying compound and at least one reactor (3) for regenerating said active compound, said chemical loop (8, 9) relating to said particles;
a reactor (12) for oxidizing a gas (11), having at least one inlet for said gas (11) to be oxidized and at least one other inlet connected to a source of gas containing predominantly oxygen (13); and
at least two heat exchangers (10a, 10b, 10c, 10d, 10e, 10f) for heating at least one heat-transfer fluid, one situated inside said plant (1) comprising a chemical loop, and the other at said reactor (12) used for oxidizing said gas (11);
wherein said inlet (11) for the gas that is to be oxidized in said oxidation reactor (12) is connected to at least one outlet (5) of said reactor (2) for oxidizing said fuel (4) in such a way as to receive effluents produced by said reactor (2) for oxidizing said fuel (4).

16. The device of claim 15, wherein the device comprises at least one steam turbine connected at input and/or in its intermediate stages to one or more steam pipes leading from said heat exchangers (10).

17. The device of claim 16, wherein said steam turbine is mechanically coupled to an electricity generator so as to be able to drive said generator.
